(19) United States
(12) Patent Application Publication
(10) Pub. No.: US 2013/0088591 A1
(43) Pub. Date: Apr. 11, 2013

(54) METHOD AND ARRANGEMENT FOR POSITIONING OF AN OBJECT IN A WAREHOUSE

(71) Applicant: Göran Backlund, Linkoping, (SE)

(72) Inventor: Göran Backlund, Linkoping, (SE)

(73) Assignee: SAAB AB, Linkoping (SE)

(21) Appl. No.: 13/703,706

(22) PCT Filed: Jul. 1, 2010
(86) PCT No.: PCT/SE2010/050755

§ 371 Date: Dec. 12, 2012

(51) Int. Cl. G06K 9/78

(52) U.S. Cl. CPC G06K 9/78
USPC 348/135

(57) ABSTRACT

An object identification and a tracking system and a method in an object identification and a tracking system for associating an object identity with a position for an object in a warehouse.

### TECHNICAL FIELD

The present invention relates to a method in an Object Identification and Tracking System, OITS, and an OITS, in particular to a method in an OITS and an OITS for determining a positioning of an object in a warehouse.

### BACKGROUND

A warehouse is often a building for storage of goods. Some warehouses are completely automated, and require no workers inside. Objects move on a system of automated conveyors. Automated storage and retrieval systems may also be used to coordinate storage and retrieval. Logistics automation software may also be used to keep track of all the objects in the warehouse. Different techniques have been tested for tracking of objects in the warehouse. For instance attaching RFID tags to the objects which can be read by different RFID readers in the warehouse in order keep track of the objects in the warehouse. A disadvantage with this solution is that an RFID tag has to be attached to every object in order to be able to track all the objects in the warehouse. A further disadvantage is that the solution requires many RFID readers in the entire warehouse in order to be able to track the objects in the entire warehouse.

There is therefore a need for an improved solution for determining a position of an object in a warehouse, which solution solves or at least mitigates at least one of the above mentioned problems.

### SUMMARY

An object of the present invention is thus to provide a method and an arrangement for determining a position of an object in a warehouse.

According to a first aspect, the present invention relates to an Object Identification and Tracking System (OITS) for associating an object identity with a first position for an object in a warehouse. The OITS comprises a number of pairs of video cameras and a processing means connected to the pairs of video cameras. The processing means being configured to determine an object identity for said object and to determine a first position for the object based on images from the pairs of video cameras. The processing means being yet further configured to associate the object identity with the first position.

Thus, one object according to the present invention is achieved by processing means being configured to determine a first position for the object based on images from the pairs of video cameras and to associate the object identity with the first position.

According to a second aspect, the present invention relates to a method in an OITS for associating an object identity with a first position for an object in a warehouse. The OITS comprises a number of pairs of video cameras and a processing means connected to the pairs of video cameras. The method comprises the steps of: determining in the processing means (220) an object identity for the object; determining in the processing means a first position for the object based on images from the pairs of video cameras; associating in the processing means the object identity with the first position.

### BRIEF DESCRIPTION OF THE DRAWINGS

The invention is described in more detail with reference to enclosed drawings, wherein:

FIG. 1 illustrates schematically an OITS according to an exemplary embodiment of the present invention.

FIG. 2 illustrates a method in an OITS according to an exemplary embodiment of the present invention.

### DETAILED DESCRIPTION

In the following description, for purposes of explanation and not limitation, specific details are set forth, such as particular sequences of steps, signalling protocols and device configurations in order to provide a thorough understanding of the present invention. It will be apparent to one skilled in the art that the present invention may be carried out in other embodiments that depart from these specific details.

Moreover, those skilled in the art will appreciate that functions and means explained herein below may be implemented using software functioning in conjunction with a programmed microprocessor or general purpose computer, and/or using an application specific integrated circuit (ASIC). It will also be appreciated that while the current invention is primarily described in the form of methods and arrangements, the invention may also be embodied in a computer program product as well as a system comprising a computer processor and a memory coupled to the processor, wherein the memory is encoded with one or more programs that may perform the functions disclosed herein.

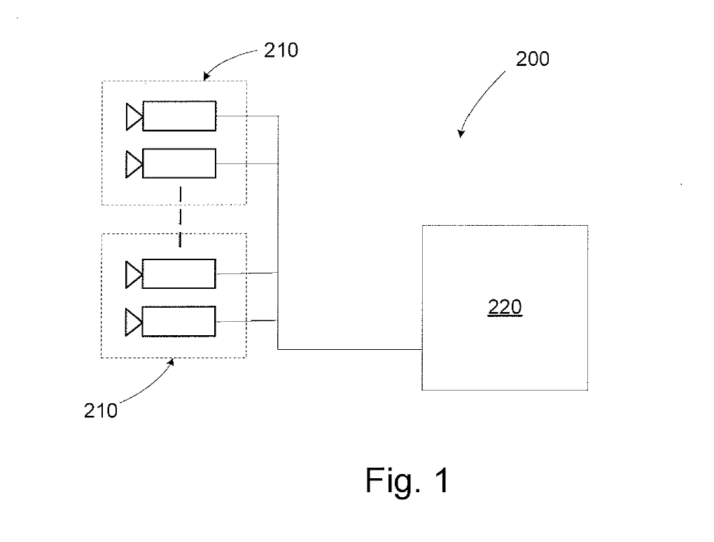

FIG. 1, illustrates an Object Identification and Tracking System 200 for associating an object identity with a first position in a warehouse according to an exemplary embodiment of the present invention. The OITS comprises a number of pairs of video cameras 210. The video cameras may be identical pairs of video cameras mounted in parallel but with a specific distance in between to achieve the stereo effect (not shown). The pairs of video cameras 210 may cover an entire warehouse floor area, but the video cameras 210 may also cover parts of the warehouse floor in case the OITS is only implemented in a part of the warehouse. The pairs of video cameras 210 may according to an exemplary embodiment of the OITS be arranged to cover a certain level above the floor area up to a top of pallet racks. The video cameras 210 may also be arranged to cover up to a roof level of the warehouse. The video cameras 210 in another exemplary embodiment of the OITS, according to the present invention are arranged in such a way that they from an altitude and with a downward angle overlook aisles of the warehouse. The video cameras 210 may be calibrated to have a floor of the warehouse as a reference value. In another exemplary embodiment of the OITS according to the present invention may the video cameras 210 have some overlapping Field Of View, FOV, in relation to adjacent video cameras 210. The object can then be handed over from one video camera to another video camera among the pairs of video cameras 210, as the object moves from one FOV to another FOV.

The OITS further comprises processing means 220 connected to the pairs of video cameras. The processing means 220 is being configured to determine an object identity for the object. The object identity may for instance be determined by the processing means 220 by receiving signals from an RFID-reader (not shown). In another exemplary embodiment of the present invention is the processing means 220 further configured to determine the object identity for the object based on images from at least one of the video cameras 210. An text label may for instance be attached to the object. Since the images taken of the object by the video cameras 210 then will contain the text pattern the identity of the object can be identified by known OCR technique in the processing means 220. The processing means 220 is further configured to determine a first position of the object based on images from the number of pairs of video cameras 210. The processing means 220 may be configured to determine the first position of the object using well known triangulation technique such as Euclidean geometry. Since a distance between the cameras in each camera pair is known, every picture element (pixel) in the FOV can be assigned with a distance from the cameras using triangulation (the two cameras and the pixel comprise a triangle). The object in question can then be identified as a set of pixels in the bitmap image that move together in a coherent fashion, through known optical flow techniques. Given the camera elevation above the floor, and also the angle between the cameras line of sight and the floor horizontal, the object spatial position in the warehouse be determined.

In an exemplary embodiment of the present invention is the first position a storage position for the object. According to the present invention is the processing means 220 further configured to associate the object identity with the first position determined by the processing means based on images from the number of pairs of video cameras 210.

In another embodiment of the present invention is the processing means 220 further configured to track the object in the warehouse based on images from the pairs of video cameras 210. The processing means 220 may in another embodiment of the present invention be further configured to track the object the entire way from when object is identified until the object reaches the first position. The processing means 220 may in another exemplary embodiment of the present invention be configured to the track the object part of a distance from where the object is identified to the first position.

In a yet further embodiment of the present invention is the processing means 220 further configured to determine a second position for the object, where the second position is a position before the storage position. In another embodiment of the present invention the processing means 220 is yet further configured to determine several positions for the object between before the storage position.

In a yet another embodiment of the OITS according to the present invention is the processing means 220 further configured to transmit the first position and the object identity from the processing means 220. The first position and the object identity may for instance be transmitted to a Warehouse Management System, WMS (not shown), where the object can be assigned with a WMS identity.

In a yet another embodiment of the OITS according to the present invention the processing means 220 is further configured to determine when the object is moved from the storage position based on images from the pairs of video cameras 210. The processing means 220 may then also be further configured to transmit information that the object is moved from the storage position. This information may for instance be transmitted to the Warehouse Management System, WMS, which replies with the WMS identity.

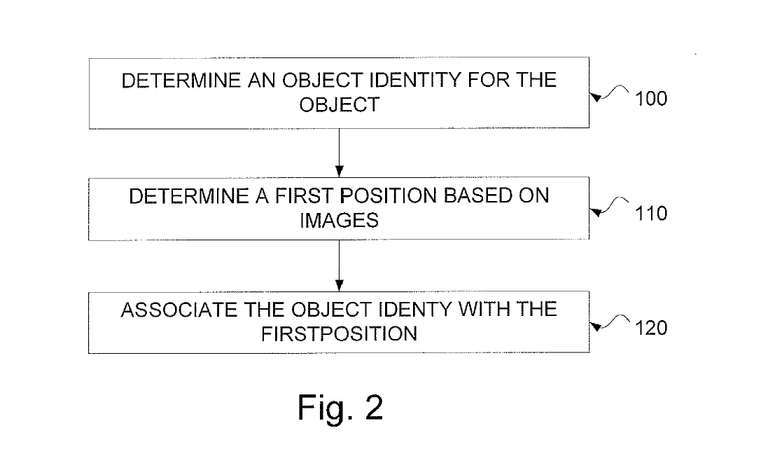

Referring to FIG. 2 there is illustrated a flowchart of a method in the OITS 200, for associating an object identity with a first position for an object in a warehouse, in accordance with previously described embodiments of the present invention. As shown in FIG. 2, the method comprises:

100 determining in the processing means 220 an object identity for the object;

110 determining in the processing means 220 a first position for the object based on images from the pairs of video cameras 210; and

120 associating in the processing means 220 the object identity with the first position.

As previously described, the method may comprise a further step of tracking in the processing means 220, the object in the ware house based on images from the pairs of video cameras 210. The method may also comprise the further step of transmitting the first position and the object identity from the processing means.

While the present invention has been described with respect to particular embodiments (including certain device arrangements and certain orders of steps within various methods), those skilled in the art will recognize that the present invention is not limited to the specific embodiments described and illustrated herein. Therefore, it is to be understood that this disclosure is only illustrative. Accordingly, it is intended that the invention be limited only by the scope of the claims appended hereto.

1. An Object Identification and Tracking System, OITS, (200) for associating an object identity with a first position for an object in a warehouse, wherein the OITS 0 comprises a number of pairs of video cameras (210) and a processing means (220) connected to the pairs of video cameras (210), the processing means (220) being configured to:
determine an object identity for said object,
determine a first position for said object based on images from said pairs of video cameras ( ) and
to associate said object identity with said first position.

2. The OITS (200) according to claim 2, wherein the processing means (220) is further configured to determine the object identity for said object based on images from at least one of said video cameras (210).

3. The OITS (200) according to any of claims 1 to 2, wherein the processing means (220) is further configured to track said object in said ware house based on images from said pairs of video cameras (210).

4. The OITS (200) according to any of claims 1 to 3, wherein the first position is a storage position.

5. The OITS (200) according to claim 4, wherein the processing means (220) is further configured to determine a second position, said second position being a position before said storage position.

6. The OITS (200) according to any of claims 1 to 5, wherein the processing means (220) is further configured to transmit the first position and said object identity from said processing means (220).

7. A method in an Object Identification and Tracking System, OITS (200), for associating an object identity with a first position for an object in a warehouse, wherein the OITS (200) comprises a number of pairs of video cameras (210) and a processing means (220) connected to the pairs of video cameras (210), the method comprises the steps of:
determining (100) in said processing means (220) an object identity for said object;
determining (110) in said processing means (220) a first position for said object based on images from said pairs of video cameras (210); and
associating (120) in said processing means (220) said object identity with said first position.

8. The method according to claim 7, wherein in the step of determining an object identity said object identity is determined based on images from at least one of said video cameras (210);

9. The method according to any of claims 7 to 8, wherein the method 20 comprises the further step tracking in said processing means (220), said object in said ware house based on images from said pairs of video cameras (210);

10. The method according to any of claims 7 to 9, wherein the first position is a storage position.

11. The method according to claim 10, wherein the said step of determining a storage position further comprises determining a second position, said second position being a position before said storage position.

12. The method according to any of claims 7 to 11, wherein the method comprises the further step transmitting said first position and said object identity from said processing means (220).
